(19) United States
(12) Patent Application Publication
(10) Pub. No.: US 2005/0213771 A1
(43) Pub. Date: Sep. 29, 2005

(54) Propagating sound information to acoustically isolated environments

(76) Inventors: Paris Smaragdis, Brookline, MA (US); Joseph W. Marks, Belmont, MA (US)

Correspondence Address: Patent Department;Mitsubishi Electric Research Laboratories, Inc., 201 Broadway, Cambridge, MA, 02139, US

(21) Appl. No.: 10/810,438

(22) Filed: Mar. 26, 2004

(51) Int. Cl. H04R 29/00

(52) U.S. Cl. 381/56; 381/57

(57) ABSTRACT

A method and system propagates only interesting sound information to a user who is otherwise acoustically isolated from sound. This is a task particularly useful for people that work in, or enjoy noisy environments, and are placed in a soundproof room, or are otherwise unable to detect critical sounds. By automatically detecting critical sounds, the user can be alerted by a signal generated in response to detecting the selected sound information.

### FIELD OF THE INVENTION

The present invention relates generally to detecting sound information in open environments, and more particularly to propagating selected sound information acquired in the open environments to acoustically isolated environments.

### BACKGROUND OF THE INVENTION

As acoustics technology is finding more and more applications, users of modern acoustic technology have increased control over acoustic environments. Whether in one's home, office, car or on the street, sounds can be suppressed passively using sound insulation, or actively by masking with preferred sounds such as music. Although this acoustic isolation from sound is appreciated, it is often blamed when crucial sound information does not reach our ears. Sounds are an extremely efficient means by which to evaluate our environment and being cut-off from sounds can often cause problems.

To illustrate this issue consider a few example applications. Nowadays, a driver enjoys the luxury of good sound insulation and the ability to turn up the radio so that sounds outside a car, in the open environment are virtually imperceptible in the acoustically isolated environment inside the car. Obviously this is a good thing when it comes to everyday comfort. However, sound isolation can also constitute a severe hazard when the driver is unable to hear warning sounds from other vehicles, even worse sirens of emergency vehicles.

Likewise the dweller of a quiet office is often unaware when being called for, or when some emergency has arisen. A pedestrian or bicycler is also at risk when listening to music through headphones.

These are all applications where a misunderstanding or an emergency could arise. If the people in these examples had the ability to selectively allow certain sounds to reach their ears, then they would be in a better position to react appropriately. The use of plain sound insulation and reproduction technology makes this very hard because all outside sounds are equally suppressed.

Therefore, there is a need for a system and method for propagating sounds to an otherwise acoustically isolated listener.

### SUMMARY OF THE INVENTION

The system according to the invention detects selected sound information in real-time, and propagates the selected information to listeners.

The system constantly monitors an open acoustic environment and then conveys only the relevant information to an otherwise acoustically isolated listener. The information can be conveyed either in terms of a visual message or an audio message, or both.

### BRIEF DESCRIPTION OF THE DRAWINGS

FIG. 1 is block diagram of a system and method for selectively propagating sound information according to the invention.

### DETAILED DESCRIPTION OF THE PREFERRED EMBODIMENTS

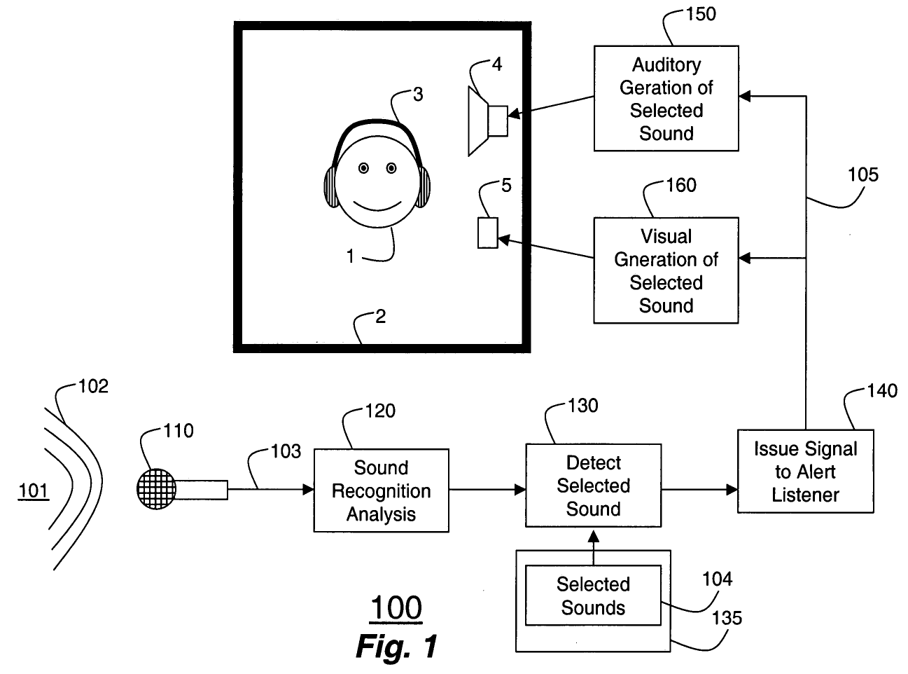

FIG. 1 shows a system 100 for propagating selected sound information according to the invention. From an open environment 101, e.g., a room or a street, sound information 102 is acquired by a microphone 110, and converted to an audio signal 103.

The audio signal 103 is analyzed 120 to detect 130 one or more of a set of selected sounds 104 stored in a memory 135. The selected sounds 104 can be predetermined. The selected sounds can be important, critical, or interesting sounds, such as produced by car horns, sirens, alarms, telephones and door bells, or a baby crying.

After a particular selected sound has been detected, a signal 105 is generated 140 to alert a user 1 who is acoustically isolated from the open environment 101. For example, the user is in a soundproof room 2, or the user is wearing headphones 3 that mask the sound information 102. In either case, the user is said to be in an acoustically isolated environment. The signal 105 can be an auditory generation 150 of the original sound information 102 via a loudspeaker 4 or the headphones 3, or a visual generation 160 via display device 5, e.g., a light, a LED, or a LCD, or some other audio or visual signal.

Applications

Vehicles

The invention is suited for the following applications. Modern cars provide excellent sound isolation capabilities. In addition, automotive audio systems can provide enough sound inside the car to mask the sound information 102 from the open environment 101 outside the car. Enclosed in such an acoustically isolated environment 2, the driver 1 can easily become oblivious of honks, sirens or even car malfunctions. By placing the microphone 110 in the open environment 101 outside the car 2, the system 100 can detect the honking of nearby cars, emergency vehicle sirens or even sounds that indicate car malfunctions. Upon detecting 130 this selected sound information, the signal 105 can be generated using either the audio system 4, or a light in a car console 5.

If multiple microphones are used, then it is possible to determine a direction of the sound information 102, which can also be propagated via the signal 105. If multiple loudspeakers are used, then the originating direction of the selected sound information can be simulated stereo audio techniques.

Headphones

Modern headphones can play music very loud. Some headphones also provide noise canceling to minimize an amount of external sounds that reach the ears of the user. If a person is wearing such headphones while in the open environment, e.g., riding a bicycle on a busy street, or crossing a busy intersection, then the user is a risk if selected sound information, such as car toots, cannot be heard. The system according to the invention can propagate just the selected sounds to the user of the system.

Homes

In a large house, it can be difficult to hear an infant in another room. The system 100 is capable to propagate a baby's cry to a parent acoustically isolated from the infant. Similarly, the system can also detect gates or doors being opened, doorbells, pets outside, household appliances malfunctioning, and so forth. Using speech identification technology it is also possible to program the system to respond only to speech from persons having predetermined identities.

Effect of the Invention

A method and system detect selected sound information, and propagates that information to a user in an acoustically isolated environment by either an audio or a visual signal.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

1. A method for propagating sound information, comprising:
acquiring sound information in an open environment;
analyzing the sound information to detect selected sound information; and
propagating the selected sound information to an acoustically isolated environment.

2. The method of claim 1, further comprising:
storing the selected sound information in a memory.

3. The method of claim 1, in which the selected sound information is predetermined.

4. The method of claim 1, in which the propagating generates an audio signal corresponding the selected sound signal.

5. The method of claim 1, in which the propagating generates a visual signal corresponding the selected sound signal.

6. The method of claim 1, in which the selected sound information is propagated to a user in a soundproof environment.

7. The method of claim 1, in which the soundproof environment is a room.

8. The method of claim 1, in which the soundproof environment is a car.

9. The method of claim 1, in which the acoustically isolated environment is provided by headphones.

10. The method of claim 1, in which the selected sound information is selected from a group consisting of car honks, sirens, car malfunctions, cries, and bells.

11. The method of claim 1, in which the selected sound information is speech of a person having a predetermined identity.

12. The method of claim 1, further comprising:
indicating a direction of the selected sound information.

13. The method of claim 12, in which the direction is indicated visually.

14. The method of claim 12, in which the direction is indicated acoustically by a stereo signal.

15. A system for propagating sound information, comprising:
a microphone configured to acquiring sound information in an open environment;
means, connected to the microphone, for analyzing the sound information to detect selected sound information; and
means, connected to the means for analyzing, for propagating the selected sound information to an acoustically isolated environment.

16. The system of claim 15, further comprising:
a memory configured to store the selected sound information.

17. The system of claim 15, in which the means for propagating is a loudspeaker.

18. The system of claim 15, in which the means for propagating is a display device.

19. The system of claim 15, in which the means for propagating includes a loudspeaker and a display device.

20. The system of claim 15, further comprising:
means for indicating a direction of the selected sound information.
